(19) United States
(12) Patent Application Publication
(10) Pub. No.: US 2025/0240851 A1
(43) Pub. Date: Jul. 24, 2025

(54) HEAT EXCHANGER

(71) Applicant: Niterra Co., Ltd., Nagoya-shi (JP)

(72) Inventors: Yusuke MAKINO, Nagoya-shi (JP); Hiroki HATTORI, Nagoya-shi (JP); Atsutoshi SUGIYAMA, Nagoya-shi (JP); Kazuki TANIZAWA, Nagoya-shi (JP)

(21) Appl. No.: 19/033,000

(22) Filed: Jan. 21, 2025

(30) Foreign Application Priority Data
Jan. 23, 2024 (JP) 2024-008032
Nov. 14, 2024 (JP) 2024-199133

(51) Int. Cl. H05B 3/46; F24H 1/00; F24H 9/13; H05B 3/04

(52) U.S. Cl. CPC H05B 3/46; H05B 3/04; F24H 1/009; F24H 9/13; H05B 2203/021

(57) ABSTRACT

A heat exchanger to be mounted to a vehicle includes: a ceramic heater including an insulation tube extending in an axial-line direction, a first flange located on one side in the axial-line direction and having a diameter expanding radially outward from an outer periphery of the insulation tube, a terminal portion located toward the one side relative to the first flange, and a heating portion located toward another side in the axial-line direction relative to the first flange; and a housing in which the insulation tube is stored and to which the ceramic heater is fixed in a watertight state via the first flange. The ceramic heater includes a second flange located away from the first flange in the axial-line direction and having a diameter expanding radially outward from the outer periphery of the insulation tube, and is fixed to the housing via the second flange.

### TECHNICAL FIELD

The present disclosure relates to a heat exchanger.

### BACKGROUND ART

Conventionally, an electric-heat-generation warm water heating device described in Japanese Patent Application Laid-Open (kokai) No. 2013-126844 (Patent Document 1 below) is known. The electric-heat-generation warm water heating device in Patent Document 1 includes a case having an inlet, a flow channel, and an outlet for a heat medium, and a ceramic heater provided in the flow channel. A flange is attached to an outer periphery on a terminal portion side of the ceramic heater. The flange is attached to an inner peripheral surface of an insertion opening provided to the case via a seal member such as an O ring, whereby the ceramic heater is fixed in the case.

### PRIOR ART

[Patent Document 1] Japanese Patent Application Laid-Open (kokai) No. 2013-126844

### SUMMARY OF THE INVENTION

In the above configuration, the ceramic heater is fixed to the case via one flange. Therefore, for example, if the electric-heat-generation warm water heating device is for a vehicle, there is a concern that, due to vibration of the vehicle, or the like, stress concentrates on a fixation part between the flange and the case or a fixation part between the ceramic heater and the flange.

The present disclosure has been made in view of the above circumstances, and an object of the present disclosure is to provide a heat exchanger in which stress concentration on a fixation part of the ceramic heater can be suppressed.

A heat exchanger according to the present disclosure is a heat exchanger to be mounted to a vehicle and includes: a ceramic heater including an insulation tube having a tubular shape and extending in an axial-line direction, a first flange located on one side in the axial-line direction of the insulation tube and having a diameter expanding radially outward from an outer periphery of the insulation tube, a terminal portion located toward the one side in the axial-line direction of the insulation tube relative to the first flange, and a heating portion located toward another side in the axial-line direction of the insulation tube relative to the first flange; and a housing in which the insulation tube is stored (i.e., positioned, held, accommodated, contained, housed) and to which the ceramic heater is fixed in a watertight state via the first flange. The ceramic heater includes a second flange located away from the first flange in the axial-line direction and having a diameter expanding radially outward from the outer periphery of the insulation tube, and is fixed to the housing via the second flange.

According to the present disclosure, it is possible to provide a heat exchanger in which stress concentration on a fixation part of the ceramic heater can be suppressed.

### BRIEF DESCRIPTION OF THE DRAWINGS

FIG. 1 is a sectional view showing the entire configuration of a heat exchanger according to embodiment 1.

FIG. 2 is a sectional view of the heat exchanger showing the internal structure of a ceramic heater.

FIG. 3 is a view illustrating a manufacturing process for an insulation tube.

FIG. 4 is an enlarged sectional view of the ceramic heater showing parts where a first flange and a second flange are attached.

FIG. 5 is a sectional view of a heat exchanger showing the internal structure of a ceramic heater according to embodiment 2.

FIG. 6 is a sectional view of a heat exchanger showing the internal structure of a ceramic heater according to embodiment 3.

### DESCRIPTION OF THE INVENTION

First, embodiments of the present disclosure will be listed and described.

(1) A heat exchanger according to the present disclosure is a heat exchanger to be mounted to a vehicle and includes: a ceramic heater including an insulation tube having a tubular shape and extending in an axial-line direction, a first flange located on one side in the axial-line direction of the insulation tube and having a diameter expanding radially outward from an outer periphery of the insulation tube, a terminal portion located toward the one side in the axial-line direction of the insulation tube relative to the first flange, and a heating portion located toward another side in the axial-line direction of the insulation tube relative to the first flange; and a housing in which the insulation tube is stored and to which the ceramic heater is fixed in a watertight state via the first flange. The ceramic heater includes a second flange located away from the first flange in the axial-line direction and having a diameter expanding radially outward from the outer periphery of the insulation tube, and is fixed to the housing via the second flange.

With this configuration, the ceramic heater is fixed to the housing by the first flange and the second flange, and thus stress applied to a fixation part between the ceramic heater and the housing under a vibration environment can be distributed to two locations. In addition, as compared to a case where only one fixation part between the flange and the insulation tube is provided, stress can be distributed to a fixation part between the first flange and the insulation tube, and a fixation part between the second flange and the insulation tube.

(2) In the heat exchanger described in (1), preferably, the first flange and the second flange are fixed to an inner peripheral surface of the housing via seal members provided around outer peripheries of the first flange and the second flange.

With this configuration, the first flange and the second flange can be fixed to the housing in a watertight state.

(3) In the heat exchanger described in (1), preferably, the second flange is located toward the one side in the axial-line direction relative to the terminal portion.

With this configuration, a space between the first flange and the second flange located away from each other in the axial-line direction can be effectively used, whereby the heat exchanger can be downsized.

(4) In the heat exchanger described in (3), preferably, the second flange is fixed to the housing in a watertight state.

Since the first flange and the second flange are fixed to the housing in a watertight state, water leakage to the terminal portion provided between the first flange and the second flange can be prevented.

(5) In the heat exchanger described in (1), preferably, the second flange is located toward the other side in the axial-line direction relative to the terminal portion.

With this configuration, the one side in the axial-line direction relative to the terminal portion is fixed by the first flange and the other side in the axial-line direction relative to the terminal portion is fixed by the second flange, whereby vibration on the other side of the ceramic heater is readily suppressed, so that stress concentration on the fixation part between the ceramic heater and the first flange can be suppressed.

(6) In the heat exchanger described in any one of (1) to (3), preferably, the housing includes a first housing in which the insulation tube is stored, a third housing attached to the first housing and fixed to the first flange in a watertight state, and a second housing formed as a separate body from the third housing and fixed to the second flange, and the first flange has a held portion held between the first housing and the third housing in the axial-line direction.

With this configuration, the heat exchanger can be easily attached. In addition, the ceramic heater can be positioned in the axial-line direction.

(7) In the heat exchanger described in any one of (1) to (3), preferably, the housing includes a first housing in which the insulation tube is stored, and a second housing fixed to the second flange, and the first flange has a held portion held between the first housing and the second housing in the axial-line direction.

With this configuration, the first flange can be fixed to the housing by the first housing and the second housing holding the held portion.

### DETAILS OF EMBODIMENTS OF THE PRESENT DISCLOSURE

### Embodiment 1

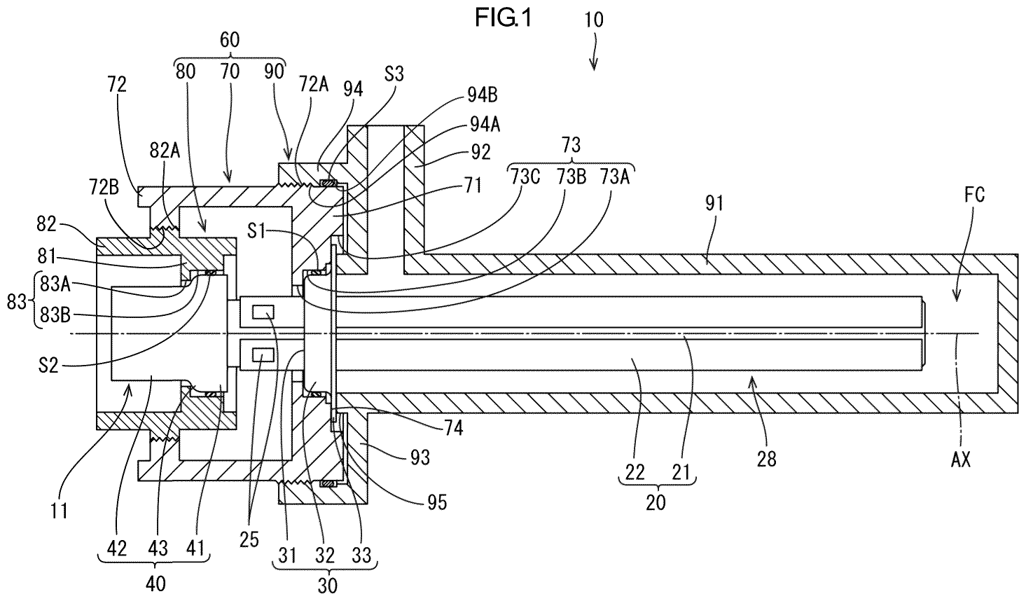

Embodiment 1 of the present disclosure will be described with reference to FIG. 1 to FIG. 4. The present disclosure is not limited to examples described herein. The present disclosure is indicated by the scope of the claims and is intended to include all modifications within a gist and a scope that are equivalent to the scope of the claims. In the following description, for a plurality of identical members, only some of these members may be denoted by reference characters and reference characters of the other members may be omitted.

### Heat Exchanger

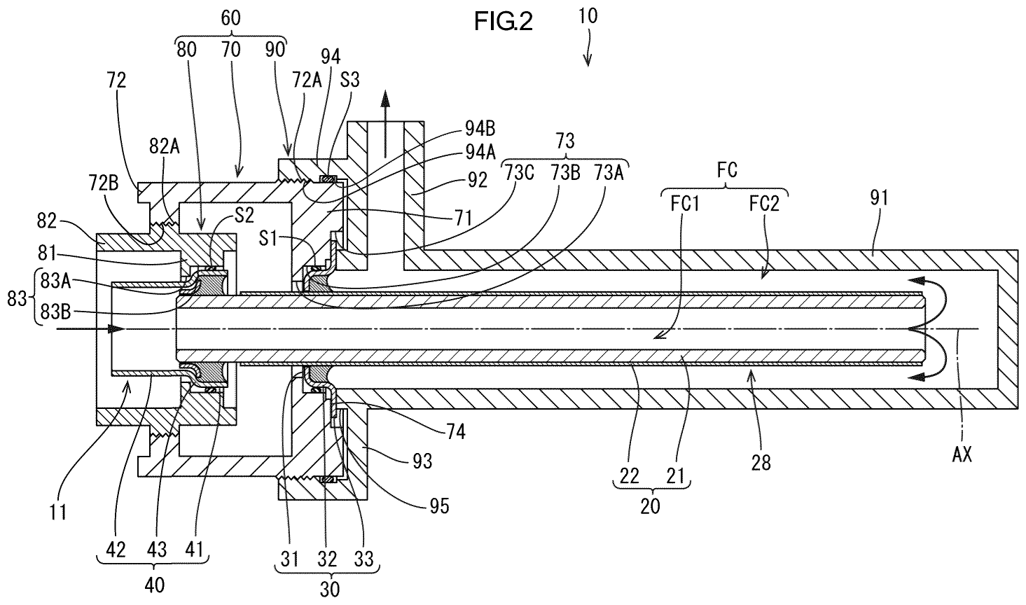

A heat exchanger 10 according to the present embodiment is a device for heating a liquid such as water. For example, the heat exchanger 10 is mounted to a vehicle such as an electric vehicle (EV) and is used for heating a vehicle compartment or retaining heat of a battery. As shown in FIG. 1 and FIG. 2, the heat exchanger 10 includes a ceramic heater 11, and a housing 60 storing the ceramic heater 11.

### Ceramic Heater

The ceramic heater 11 includes an insulation tube 20, a first flange 30, a second flange 40, and terminal portions 25. The insulation tube 20 has a cylindrical shape centered at an axial line AX. The insulation tube 20 extends in the axial-line direction (the direction in which the axial line AX extends). The insulation tube 20 includes a ceramic tube 21 having a cylindrical shape, and a ceramic layer 22 coating almost the entirety of the outer periphery of the ceramic tube 21. The ceramic tube 21 and the ceramic layer 22 are made of a ceramic material such as alumina, for example.

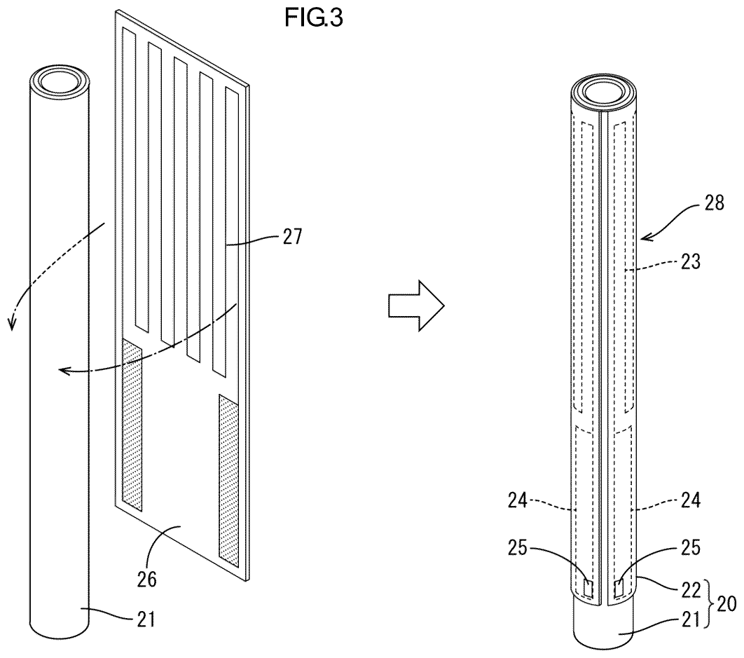

As shown in FIG. 3, a heater pattern layer 23 and a pair of internal terminals 24 are formed at an inner peripheral surface (a surface on the ceramic tube 21 side) of the ceramic layer 22 or inside thereof. The heater pattern layer 23 has a meandering thin line shape. The internal terminals 24 have rectangular shapes that are wider as compared to the heater pattern layer 23. The internal terminals 24 are electrically connected to terminal portions 25 through via-conductors (not shown). The terminal portions 25 are formed at the outer peripheral surface of the ceramic layer 22.

The insulation tube 20 can be manufactured by, for example, winding a ceramic sheet 26 around the ceramic tube 21 calcined in advance and then sintering these. A conductor layer 27 of tungsten or the like is formed at a surface of the ceramic sheet 26 or inside thereof. After sintering, the conductor layer 27 becomes the heater pattern layer 23, the internal terminals 24, and the terminal portions 25.

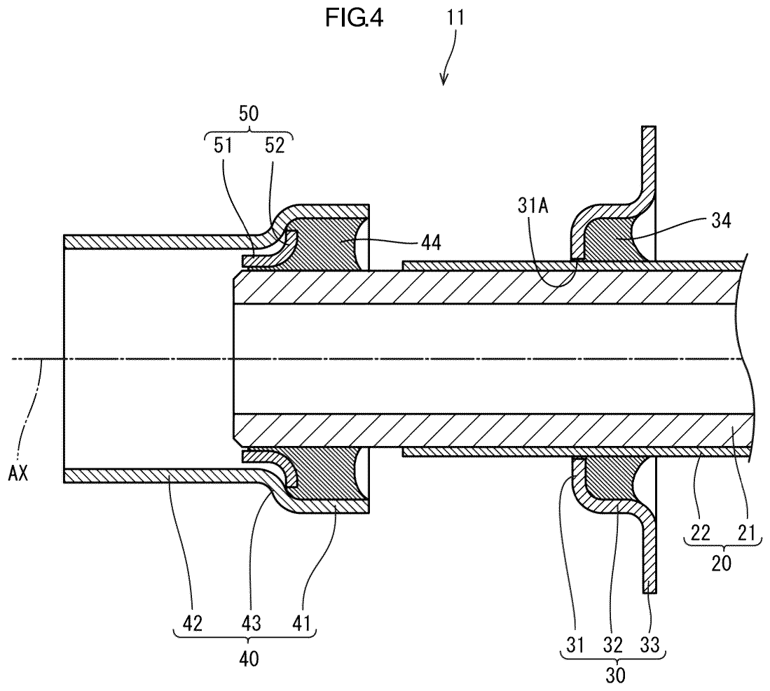

The first flange 30 is an annular member made of metal such as stainless steel, for example. The first flange 30 has approximately a cup shape, for example. The first flange 30 has a bottom portion 31, a peripheral wall portion 32, and a held portion 33. As shown in FIG. 4, the first flange 30 has a through hole 31A penetrating the bottom portion 31 in the axial-line direction. The peripheral wall portion 32 has substantially a cylindrical shape and extends in the axial-line direction from the outer peripheral edge of the bottom portion 31. The held portion 33 has a plate shape and extends radially outward from an end of the peripheral wall portion 32 on a side opposite to the bottom portion 31. Here, a radial direction is a direction perpendicular to the axial-line direction, and is a direction in which a virtual axis crossing the axial line AX extends. A radially outward direction is a direction to go away from the axial line AX, along the virtual axis. A radially inward direction is a direction to approach the axial line AX, along the virtual axis.

The first flange 30 is fixed to the insulation tube 20 in a state in which the insulation tube 20 is inserted through the through hole 31A. Specifically, a space formed by the bottom portion 31, the peripheral wall portion 32, and the outer peripheral surface of the insulation tube 20 is filled with glass 34, whereby the first flange 30 is fixed to the insulation tube 20. The first flange 30 is located on one side (left side in FIG. 1 and FIG. 2) in the axial-line direction of the insulation tube 20, and has a diameter expanding radially outward from the outer periphery of the insulation tube 20. As shown in FIG. 1, the terminal portions 25 are located toward the one side in the axial-line direction relative to the first flange 30.

The second flange 40 is an annular member made of metal such as stainless steel, for example. The second flange 40 has approximately a tubular shape, for example. The second flange 40 includes a large-diameter portion 41, a small-diameter portion 42 having a smaller diameter than the large-diameter portion 41, and a connection portion 43 having a stepped shape and connecting the large-diameter portion 41 and the small-diameter portion 42 in the axial-line direction.

As shown in FIG. 4, the second flange 40 is fixed to the insulation tube 20 in a state in which an end on the one side in the axial-line direction of the insulation tube 20 is inserted inside the second flange 40. Specifically, a space surrounded by the outer peripheral surface of the insulation tube 20, the inner peripheral surface of the second flange 40 from the large-diameter portion 41 to the connection portion 43, and a spacer 50 described later, is filled with glass 44, whereby the second flange 40 is fixed to the insulation tube 20.

The outer diameter of the insulation tube 20 is smaller than the inner diameter of the small-diameter portion 42, and a gap is formed between the outer peripheral surface of the insulation tube 20 and the inner peripheral surfaces of the small-diameter portion 42 and the connection portion 43. The spacer 50 is placed in the gap, thereby forming a space where the glass 44 for fixing the second flange 40 to the insulation tube 20 is stored. The spacer 50 has a tubular portion 51 having a cylindrical shape and extending in the left-right direction, and a brim 52 protruding radially outward from the end edge of the tubular portion 51. The inner peripheral surface of the tubular portion 51 is located along the outer peripheral surface of the insulation tube 20. The brim 52 is located in contact with the inner peripheral surface of the connection portion 43.

The second flange 40 is located away from the first flange 30 in the axial-line direction, and has a diameter expanding radially outward from the outer periphery of the insulation tube 20. The second flange 40 is located toward the one side in the axial-line direction relative to the first flange 30. As shown in FIG. 1, the second flange 40 is located toward the one side in the axial-line direction relative to the terminal portions 25.

Liquid leakage is prevented at a part where each flange 30, 40 and the insulation tube 20 are connected (i.e., a part sealed with the glass 34, 44), of the ceramic heater 11. As the glass 34, 44, for example, Na₂O·Al₂O₃·B₂O₃·SiO₂-based glass, so-called Al₂O₃·B₂O₃·SiO₂-based glass (borosilicate glass), is used.

### Housing

As shown in FIG. 1 and FIG. 2, the housing 60 stores the ceramic heater 11. The housing 60 forms a part of a flow channel FC through which the liquid flows. The housing 60 fixes the ceramic heater 11 in a watertight state via the first flange 30. In addition, the housing 60 fixes the ceramic heater 11 via the second flange 40. Specifically, the housing 60 may fix the ceramic heater 11 in a watertight state via the second flange 40. Here, fixation in a watertight state means that a plurality of members are fixed by a fixation part and liquid leakage through the fixation part is prevented.

The housing 60 includes a third housing 70, a second housing 80, and a first housing 90 which are formed as separate bodies. The third housing 70 is attached to the second housing 80. The first housing 90 is attached to the third housing 70. The third housing 70 is fitted to the first flange 30 in a watertight state. The second housing 80 is fitted to the second flange 40 in a watertight state.

Here, fitting in a watertight state means that a plurality of members are fitted at a fitting part and liquid leakage through the fitting part is prevented.

### First Housing

The first housing 90 stores, of the insulation tube 20, a part on a side opposite to a part where the first flange 30, the terminal portions 25, and the second flange 40 are located, in the axial-line direction. Of the insulation tube 20, the part located in the first housing 90 is, as shown in FIG. 3, a part including most of the heater pattern layer 23 and is a part to be mainly heated when the ceramic heater 11 is energized (hereinafter, this part is referred to as a heating portion 28). As shown in FIG. 1 and FIG. 2, the heating portion 28 is located toward the other side (right side in FIG. 1 and FIG. 2) in the axial-line direction of the insulation tube 20 relative to the first flange 30.

As shown in FIG. 1 and FIG. 2, the first housing 90 includes an insulation tube storage portion 91 in which the heating portion 28 of the insulation tube 20 is stored, a discharge pipe 92 formed in communication with the insulation tube storage portion 91, a base wall 93 extending radially outward from an end on the one side in the axial-line direction of the insulation tube storage portion 91, and a surrounding wall 94 extending toward the one side in the axial-line direction from the base wall 93. The insulation tube storage portion 91 has a bottomed tubular shape. The inner diameter of the insulation tube storage portion 91 is larger than the outer diameter of the insulation tube 20. The discharge pipe 92 extends radially outward from the end on the one side in the axial-line direction of the insulation tube storage portion 91, for example.

A part of the third housing 70 described later is stored in a space formed by the base wall 93 and the surrounding wall 94. An internal thread 94A is formed on the inner peripheral surface of the surrounding wall 94. The internal thread 94A is to be screwed with an external thread 72A formed on the outer peripheral surface of the third housing 70. On the inner peripheral surface of the surrounding wall 94, a seal groove 94B where a seal member S3 is placed is formed between the internal thread 94A and the base wall 93. The seal member S3 has an annular shape and makes sealing between the outer peripheral surface of the third housing 70 and the inner peripheral surface of the surrounding wall 94, in a liquid-tight state.

The first housing 90 has a first contact portion 95 which comes into contact with the held portion 33 of the first flange 30 from the other side (right side in FIG. 1 and FIG. 2) in the axial-line direction. The first contact portion 95 may protrude toward the one side in the axial-line direction from the base wall 93, for example.

### Third Housing

The third housing 70 includes a base wall 71 extending in the radial direction, and a surrounding wall 72 extending toward the one side in the axial-line direction from the base wall 71. The third housing 70 has a first storage portion 73 penetrating the base wall 71. The first storage portion 73 includes a first tube portion 73A through which the insulation tube 20 is inserted, a second tube portion 73B in which the peripheral wall portion 32 of the first flange 30 is stored, and a third tube portion 73C in which the held portion 33 is stored. The inner diameter of the third tube portion 73C is larger than the inner diameter of the second tube portion 73B. The inner diameter of the second tube portion 73B is larger than the inner diameter of the first tube portion 73A.

The inner peripheral surface of the second tube portion 73B fixes the peripheral wall portion 32 of the first flange 30 via a seal member S1 in a watertight state. In other words, the annular seal member S1 is attached to the outer peripheral surface of the peripheral wall portion 32, and the first flange 30 is fixed to the inner peripheral surface of the second tube portion 73B via the seal member S1. The seal member S1 may be attached to a seal groove (not shown) provided at the inner peripheral surface of the second tube portion 73B. The seal member S1 is compressed in the radial direction between the outer peripheral surface of the peripheral wall portion 32 and the inner peripheral surface of the second tube portion 73B. That is, the first flange 30 is fixed in the radial direction by the second tube portion 73B of the third housing 70. The seal member S1 can prevent the liquid from leaking to the one side in the axial-line direction from the first housing 90 side of the first storage portion 73. Thus, the liquid passing through the flow channel FC can be prevented from leaking out to the terminal portion 25 side.

The third housing 70 has a second contact portion 74 which comes into contact with the held portion 33 of the first flange 30 from the one side in the axial-line direction. The second contact portion 74 is located at a step part connecting the third tube portion 73C and the second tube portion 73B. The held portion 33 is held in the axial-line direction between the first contact portion 95 and the second contact portion 74. That is, the first flange 30 is fixed in the axial-line direction by the third housing 70 and the first housing 90.

The terminal portions 25, wiring members (not shown) connected to the terminal portions 25, and a part of the second housing 80 described later, are located in a space formed by the surrounding wall 72 and the base wall 71. The external thread 72A is formed on the outer peripheral surface of the surrounding wall 72. The external thread 72A is located at a position near an end on the other side in the axial-line direction, of the surrounding wall 72. The external thread 72A is to be screwed with the internal thread 94A of the first housing 90. An internal thread 72B is formed on the inner peripheral surface of the surrounding wall 72. The internal thread 72B is to be screwed with an external thread 82A formed on the outer peripheral surface of the second housing 80. The internal thread 72B is located at a position near an end on the one side in the axial-line direction, of the surrounding wall 72. The surrounding wall 72 may have a through hole (not shown) for leading the wiring member to outside, for example.

### Second Housing

The second housing 80 includes a base wall 81 extending in the radial direction, and a surrounding wall 82 extending toward the one side in the axial-line direction from the base wall 81. The second housing 80 has a second storage portion 83 penetrating the base wall 81. The second storage portion 83 includes a first tube portion 83A through which the small-diameter portion 42 of the second flange 40 can be inserted, and a second tube portion 83B in which the large-diameter portion 41 of the second flange 40 is stored. The inner diameter of the second tube portion 83B is larger than the inner diameter of the first tube portion 83A. A part of the connection portion 43 of the second flange 40 may be stored in the first tube portion 83A, and the other part of the connection portion 43 may be stored in the second tube portion 83B. The entirety of the connection portion 43 may be stored in the second tube portion 83B.

The inner peripheral surface of the second tube portion 83B fixes the large-diameter portion 41 of the second flange 40 in a watertight state via a seal member S2. In other words, the annular seal member S2 is attached to the outer peripheral surface of the large-diameter portion 41, and the second flange 40 is fixed to the inner peripheral surface of the second tube portion 83B via the seal member S2. The seal member S2 may be attached to a seal groove (not shown) provided at the inner peripheral surface of the second tube portion 83B. The seal member S2 is compressed in the radial direction by the outer peripheral surface of the large-diameter portion 41 and the inner peripheral surface of the second tube portion 83B. That is, the second flange 40 is fixed in the radial direction by the second tube portion 83B of the second housing 80. The seal member S2 can prevent the liquid from leaking from the one side to the other side in the axial-line direction of the second storage portion 83. Thus, the liquid passing through the flow channel FC can be prevented from leaking out to the terminal portion 25 side.

The small-diameter portion 42 of the second flange 40 is located in a space formed by the surrounding wall 82 and the base wall 81. The external thread 82A is formed on the outer peripheral surface of the surrounding wall 82. The external thread 82A is located at a position near an end on the other side in the axial-line direction, of the surrounding wall 82. The external thread 82A is to be screwed with the internal thread 72B of the third housing 70.

As shown in FIG. 2, the heat exchanger 10 has the flow channel FC through which the liquid as a heating target flows. The flow channel FC includes a first flow channel FC1 formed inside the ceramic heater 11, and a second flow channel FC2 formed mainly by the first housing 90. The first flow channel FC1 includes an internal space in the small-diameter portion 42 and an internal space in the insulation tube 20. The second flow channel FC2 is sealed in a watertight state by the seal members S1 and S3. As shown by arrows, the liquid is introduced from the small-diameter portion 42, and passes through the heating portion 28 of the insulation tube 20, to enter the second flow channel FC2. Thereafter, the liquid moves toward the one side in the axial-line direction while being thermally in contact with the outer peripheral surface of the heating portion 28, and then the liquid is discharged from the discharge pipe 92. The liquid is heated in the first flow channel FC1 and the second flow channel FC2. The flow channel FC may have a connection flow channel (not shown) connecting the discharge pipe 92 and the small-diameter portion 42 in a liquid-tight state, and may be configured to allow the liquid to circulate in the flow channel FC, for example.

### Effects of Embodiment 1

As described above, the heat exchanger 10 of embodiment 1 is the heat exchanger 10 to be mounted to a vehicle and includes: the ceramic heater 11 including the insulation tube 20 having a tubular shape and extending in the axial-line direction, the first flange 30 located on the one side in the axial-line direction of the insulation tube 20 and having a diameter expanding radially outward from the outer periphery of the insulation tube 20, the terminal portion 25 located toward the one side in the axial-line direction of the insulation tube 20 relative to the first flange 30, and the heating portion 28 located toward the other side in the axial-line direction of the insulation tube 20 relative to the first flange 30; and the housing 60 in which the insulation tube 20 is stored and to which the ceramic heater 11 is fixed in a watertight state via the first flange 30. The ceramic heater 11 includes the second flange 40 located away from the first flange 30 in the axial-line direction and having a diameter expanding radially outward from the outer periphery of the insulation tube 20, and is fixed to the housing 60 via the second flange 40.

With this configuration, the ceramic heater 11 is fixed to the housing 60 by the first flange 30 and the second flange 40, and thus stress applied to a fixation part between the ceramic heater 11 and the housing 60 under a vibration environment can be distributed to two locations. In addition, as compared to a case where only one fixation part between the flange and the insulation tube is provided, stress can be distributed to a fixation part between the first flange 30 and the insulation tube 20, and a fixation part between the second flange 40 and the insulation tube 20.

In embodiment 1, the first flange 30 and the second flange 40 are fixed to the inner peripheral surface of the housing 60 via the seal members S1 and S2 provided on the outer peripheries of the first flange 30 and the second flange 40.

With this configuration, the first flange 30 and the second flange 40 can be fixed to the housing 60 in a watertight state.

In embodiment 1, the second flange 40 is located toward the one side in the axial-line direction relative to the terminal portion 25, and is fixed to the housing 60 in a watertight state.

With this configuration, a space between the first flange 30 and the second flange 40 located away from each other in the axial-line direction can be effectively used, whereby the heat exchanger 10 can be downsized. In addition, since the first flange 30 and the second flange 40 are fixed to the housing 60 in a watertight state, water leakage to the terminal portion 25 provided between the first flange 30 and the second flange 40 can be prevented.

In embodiment 1, the housing 60 includes the third housing 70 fitted to the first flange 30 in a watertight state, and the second housing 80 formed as a separate body from the third housing 70 and fitted to the second flange 40 in a watertight state.

With this configuration, it becomes easy to assemble the heat exchanger 10.

In embodiment 1, the housing 60 further includes the first housing 90 attached to the third housing 70, and the first flange 30 has the held portion 33 held between the third housing 70 and the first housing 90 in the axial-line direction.

With this configuration, the ceramic heater 11 can be positioned in the axial-line direction.

### Embodiment 2

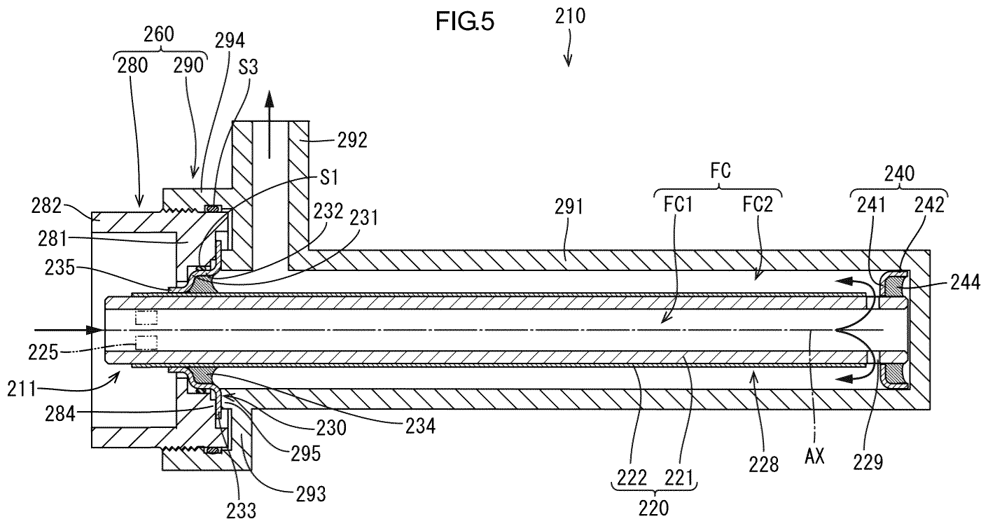

Embodiment 2 of the present disclosure will be described with reference to FIG. 5. In the following description, components corresponding to those in embodiment 1 are denoted by reference characters obtained by adding 200 to numerals of the reference characters in embodiment 1, and the description of the same components as in embodiment 1 may be omitted.

A heat exchanger 210 of embodiment 2 includes a ceramic heater 211, and a housing 260 storing the ceramic heater 211. In embodiment 1, the second flange 40 is located on the one side (left side in FIG. 1 and FIG. 2) in the axial-line direction of the insulation tube 20, whereas in embodiment 2, a second flange 240 is located on the other side (right side in FIG. 5) in the axial-line direction of an insulation tube 220.

The ceramic heater 211 includes the insulation tube 220, a first flange 230, the second flange 240, and terminal portions 225.

The first flange 230 includes a bottom portion 231 having a through hole, a first peripheral wall portion 232, a held portion 233, and a second peripheral wall portion 235. The first peripheral wall portion 232 extends toward the other side in the axial-line direction from the outer peripheral edge of the bottom portion 231. The second peripheral wall portion 235 extends toward the one side in the axial-line direction from the inner peripheral edge of the bottom portion 231. The held portion 233 extends radially outward from an end of the first peripheral wall portion 232 on a side opposite to the bottom portion 231.

The first flange 230 is fixed to the insulation tube 220 in a state in which the insulation tube 220 is inserted through the second peripheral wall portion 235. Specifically, a part where the first flange 230 and the insulation tube 220 are connected is sealed by glass 234.

The second flange 240 is located away from the first flange 230 in the axial-line direction, and has a diameter expanding radially outward from the outer periphery of the insulation tube 220. The second flange 240 is located toward the other side in the axial-line direction relative to the first flange 230. The second flange 240 is located toward the other side in the axial-line direction relative to the terminal portions 225. The second flange 240 includes a bottom portion 241, and a peripheral wall portion 242 extending toward the other side in the axial-line direction from the outer peripheral edge of the bottom portion 241. A part where the second flange 240 and the insulation tube 220 are connected is sealed with glass 244.

The housing 260 stores the ceramic heater 211. The housing 260 forms a part of the flow channel FC through which the liquid flows. The housing 260 fixes the ceramic heater 211 in a watertight state via the first flange 230. In addition, the housing 260 fixes the ceramic heater 211 via the second flange 240. Specifically, the housing 260 may fix the ceramic heater 211 in a watertight state via the second flange 240.

The housing 260 includes a second housing 280 and a first housing 290 which are formed as separate bodies. The first housing 290 is attached to the second housing 280. The second housing 280 is fitted to the first flange 230 in a watertight state.

The first housing 290 stores, of the insulation tube 220, a part on a side opposite to a part where the first flange 230 and the terminal portions 225 are located, in the axial-line direction. In the first housing 290, the second flange 240 is stored together with the insulation tube 220. A heating portion 228 is located toward the other side in the axial-line direction of the insulation tube 220 relative to the first flange 230 and toward the one side in the axial-line direction of the insulation tube 220 relative to the second flange 240. An outflow hole 229 forming a part of the flow channel FC is formed between the heating portion 228 and the second flange 240 in the insulation tube 220.

The first housing 290 includes an insulation tube storage portion 291 in which the second flange 240 and the heating portion 228 of the insulation tube 220 are stored, a discharge pipe 292 formed in communication with the insulation tube storage portion 291, a base wall 293 extending radially outward from an end on the one side in the axial-line direction of the insulation tube storage portion 291, and a surrounding wall 294 extending toward the one side in the axial-line direction from the base wall 293.

A part of the second housing 280 described later is stored in a space formed by the base wall 293 and the surrounding wall 294. An internal thread is formed on the inner peripheral surface of the surrounding wall 294, and the internal thread is to be screwed with an external thread formed on the outer peripheral surface of the second housing 280. On the inner peripheral surface of the surrounding wall 294, a seal groove where the seal member S3 is placed is formed between the internal thread and the base wall 293. The seal member S3 has an annular shape and makes sealing between the outer peripheral surface of the second housing 280 and the inner peripheral surface of the surrounding wall 294, in a liquid-tight state.

The first housing 290 has a first contact portion 295 which comes into contact with the held portion 233 of the first flange 230 from the other side in the axial-line direction. The first contact portion 295 may protrude toward the one side in the axial-line direction from the base wall 293, for example.

The second housing 280 includes a base wall 281 extending in the radial direction, and a surrounding wall 282 extending toward the one side in the axial-line direction from the base wall 281. The base wall 281 has a second contact portion 284 which comes into contact with the held portion 233 from the one side in the axial-line direction. The held portion 233 is held in the axial-line direction between the first contact portion 295 and the second contact portion 284. That is, the first flange 230 is fixed in the axial-line direction by the second housing 280 and the first housing 290.

The annular seal member S1 is attached between the second housing 280 and the first peripheral wall portion 232 of the first flange 230. The seal member S1 is compressed in the radial direction by the first peripheral wall portion 232 and the second housing 280. The seal member S1 can prevent the liquid from leaking from the inside of the first housing 290 to the inside of the second housing 280. Thus, the liquid flowing through the flow channel FC can be prevented from leaking out to the terminal portion 225 side.

### Embodiment 3

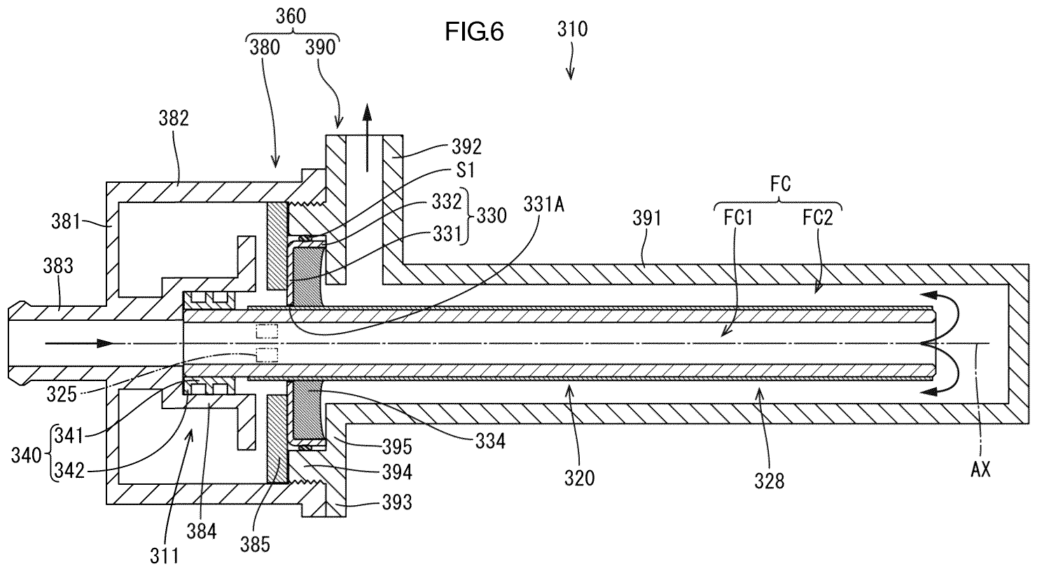

Embodiment 3 of the present disclosure will be described with reference to FIG. 6. In the following description, components corresponding to those in embodiment 1 are denoted by reference characters obtained by adding 300 to numerals of the reference characters in embodiment 1, and the description of the same components as in embodiment 1 may be omitted.

A heat exchanger 310 of embodiment 3 includes a ceramic heater 311, and a housing 360 storing the ceramic heater 311. In embodiment 1, the second housing 80 and the third housing 70 are formed as separate bodies, whereas in embodiment 3, a second housing 380 formed by integrating the second housing 80 and the third housing 70 with each other is provided.

The ceramic heater 311 includes an insulation tube 320, a first flange 330, a second flange 340, and terminal portions 325.

The first flange 330 includes a bottom portion 331 and a peripheral wall portion 332. The first flange 330 has a through hole 331A penetrating the bottom portion 331 in the axial-line direction. The peripheral wall portion 332 has substantially a cylindrical shape and extends toward the other side in the axial-line direction from the outer peripheral edge of the bottom portion 331.

The first flange 330 is fixed to the insulation tube 320 in a state in which the insulation tube 320 is inserted through the through hole 331A. Specifically, a space formed by the bottom portion 331, the peripheral wall portion 332, and the outer peripheral surface of the insulation tube 320 is filled with glass 334, whereby the first flange 330 is fixed to the insulation tube 320. The first flange 330 is located on the one side (left side in FIG. 6) in the axial-line direction of the insulation tube 320, and has a diameter expanding radially outward from the outer periphery of the insulation tube 320. The terminal portions 325 are located on the one side in the axial-line direction relative to the first flange 330.

The second flange 340 has approximately a tubular shape. The second flange 340 includes a cylindrical body portion 341, and a plurality of annular ribs 342 formed on the outer peripheral surface of the body portion 341. Each annular rib 342 protrudes radially outward from the outer peripheral surface of the body portion 341, and the plurality of annular ribs 342 are arranged at equal intervals in the axial-line direction of the insulation tube 320. In the present embodiment, three annular ribs 342 are exemplified. The second flange 340 is fixed to the insulation tube 320 in a state in which an end on the one side in the axial-line direction of the insulation tube 320 is inserted inside the second flange 340.

The housing 360 includes a second housing 380 and a first housing 390 which are formed as separate bodies. The first housing 390 is attached to the second housing 380. The first housing 390 is fitted to the first flange 330 in a watertight state.

The first housing 390 stores, of the insulation tube 320, a part on a side opposite to a part where the terminal portions 325 and the second flange 340 are located, in the axial-line direction. A heating portion 328 is located toward the other side in the axial-line direction of the insulation tube 320 relative to the first flange 330.

The first housing 390 includes an insulation tube storage portion 391 in which the heating portion 328 of the insulation tube 320 is stored, a discharge pipe 392 formed in communication with the insulation tube storage portion 391, a base wall 393 extending radially outward from an end on the one side in the axial-line direction of the insulation tube storage portion 391, and a surrounding wall 394 extending toward the one side in the axial-line direction from the base wall 393.

The first flange 330 is stored in a space formed by the base wall 393 and the surrounding wall 394. An external thread is formed on the outer peripheral surface of the surrounding wall 394. The external thread is to be screwed with an internal thread formed on the inner peripheral surface of a surrounding wall 382 described later of the second housing 380. The seal member S1 is located between the inner peripheral surface of the surrounding wall 394 and the outer peripheral surface of the peripheral wall portion 332 of the first flange 330. The seal member S1 has an annular shape and makes sealing between the outer peripheral surface of the peripheral wall portion 332 and the inner peripheral surface of the surrounding wall 394, in a liquid-tight state.

The first housing 390 has, on the radially inner side of the base wall 393, a first contact portion 395 which comes into contact with the peripheral wall portion 332 of the first flange 330 from the other side in the axial-line direction.

The second housing 380 includes a base wall 381 extending in the radial direction, the surrounding wall 382 extending toward the other side in the axial-line direction from the outer peripheral edge of the base wall 381, and a cylindrical tube channel 383 penetrating the base wall 381 in the axial-line direction. A fixation wall 384 for fixing the second flange 340 is formed at an end on the other side in the axial-line direction of the tube channel 383. The fixation wall 384 has a cylindrical shape having a larger diameter than the tube channel 383, and is formed in communication with the tube channel 383.

A retention member 385 is fixed on the other side in the axial-line direction relative to the fixation wall 384 inside the surrounding wall 382. When the second housing 380 is attached to the first housing 390, the peripheral wall portion 332 of the first flange 330 is held between the retention member 385 and the first contact portion 395, whereby the first flange 330 is fixed to the housing 360. At the same time, the second flange 340 is stored inside the fixation wall 384, whereby the second flange 340 is fixed to the housing 360. The tube channel 383 communicates with the inside of the insulation tube 320, thereby forming a part of the flow channel FC.

The seal member S1 is compressed in the radial direction between the outer peripheral surface of the peripheral wall portion 332 of the first flange 330 and the inner peripheral surface of the surrounding wall 394 of the first housing 390. That is, the first flange 330 is fixed in the radial direction by the surrounding wall 394 of the first housing 390. The seal member S1 can prevent the liquid from leaking from the inside of the first housing 390 to the inside of the second housing 380. Thus, the liquid flowing through the flow channel FC can be prevented from leaking out to the terminal portion 325 side.

### Other Embodiments

(1) In embodiment 1, the first flange 30 and the second flange 40 are each fixed to the insulation tube 20 by the glass 34, 44. However, the first flange and the second flange may be fixed to the insulation tube by other fixation members. In the embodiment, the spacer 50 is provided. However, the second flange may be fixed to the insulation tube, without using the spacer.

(2) The shapes of the first flange, the second flange, and the insulation tube may be changed as appropriate.

(3) In embodiment 1, the housing 60 includes the third housing 70, the second housing 80, and the first housing 90. However, the housing may be formed by two or less members or four or more members. The shape of the housing may be changed as appropriate.

(4) In embodiment 1, the third housing 70 and the second housing 80 are attached to each other by the external thread 82A and the internal thread 72B being screwed with each other, and the third housing 70 and the first housing 90 are attached to each other by the external thread 72A and the internal thread 94A being screwed with each other. However, the housings may be attached by another attachment method.

What is claimed is:

1. A heat exchanger to be mounted to a vehicle, comprising:
a ceramic heater including
an insulation tube having a tubular shape and extending in an axial-line direction,
a first flange located on one side in the axial-line direction of the insulation tube and having a diameter expanding radially outward from an outer periphery of the insulation tube,
a terminal portion located toward the one side in the axial-line direction of the insulation tube relative to the first flange, and
a heating portion located toward another side in the axial-line direction of the insulation tube relative to the first flange; and
a housing in which the insulation tube is stored and to which the ceramic heater is fixed in a watertight state via the first flange,
wherein the ceramic heater
includes a second flange located away from the first flange in the axial-line direction and having a diameter expanding radially outward from the outer periphery of the insulation tube, and
is fixed to the housing via the second flange.

2. The heat exchanger according to claim 1, wherein
the first flange and the second flange are fixed to an inner peripheral surface of the housing via seal members provided around outer peripheries of the first flange and the second flange.

3. The heat exchanger according to claim 1, wherein
the second flange is located toward the one side in the axial-line direction relative to the terminal portion.

4. The heat exchanger according to claim 3, wherein
the second flange is fixed to the housing in a watertight state.

5. The heat exchanger according to claim 1, wherein
the second flange is located toward the other side in the axial-line direction relative to the terminal portion.

6. The heat exchanger according to claim 1, wherein
the housing includes
a first housing in which the insulation tube is stored,
a third housing attached to the first housing and fixed to the first flange in a watertight state, and
a second housing formed as a separate body from the third housing and fixed to the second flange, and
the first flange has a held portion held between the first housing and the third housing in the axial-line direction.

7. The heat exchanger according to claim 1, wherein
the housing includes
a first housing in which the insulation tube is stored, and
a second housing fixed to the second flange, and the first flange has a held portion held between the first housing and the second housing in the axial-line direction.
